(19) United States
(12) Patent Application Publication
(10) Pub. No.: US 2011/0225230 A1
(43) Pub. Date: Sep. 15, 2011

(54) METHOD AND APPARATUS FOR DETECTING ACTIVE AND ORPHAN SESSION-BASED CONNECTIONS

(76) Inventor: Craig F. Russ, Berwyn, PA (US)

(21) Appl. No.: 12/723,858

(22) Filed: Mar. 15, 2010

(51) Int. Cl. G06F 15/173; G06F 15/16

(52) U.S. Cl. 709/203; 709/224

(57) ABSTRACT

A method and apparatus for determining whether a session-based circuit or connection between a first computing device, such as a server device, and a second computing device, such as a client device, is an active session that should remain open or an orphan session that is terminated. The method includes marking the value of a TCP/IP ACK counter, sending a NetBios KeepAlive packet from the first computing device to the second computing device. If, after a first duration of time, the value of the TCP/IP ACK counter has not changed, the connection is treated as an orphan session and terminated. If, during the first duration of time, the value of the TCP/IP ACK counter has changed due to the receipt of a TCP/IP ACK response by the first computing device from the second computing device, the connection is treated as an active session and remains open.

### BACKGROUND

1. Field

The instant disclosure relates generally to session-based connections, e.g., between a client and a server, and more particularly, to identifying active session connections that should remain open and orphan session connections that should be closed.

2. Description of the Related Art

A session is a temporary connection between two or more communication or computing devices, such as between a server device and a client device, for the purpose of interactively exchanging information between the session devices. Client/server sessions can be established using any suitable connection, such as a TCP/IP (the Internet Protocol Suite) connection or other suitable session-based network connection. One or more communication protocols provides the set of rules for and controls the exchange of information between the session devices.

In the context of a session-based client/server protocol, such as a network file sharing protocol, e.g., the Common Internet File System (CIFS) File Access Protocol, it is possible from the perspective of the server for a client to go away from an active session without cleanly closing the session, and then later establish a new active session, e.g., over a new TCP/IP connection. The initial session thus becomes an orphan session. The orphan session can be caused by one or more conditions or occurrences, including a loss of network connection, a loss of power at the client device, or a system crash at the client device. However, it also is possible that the initial session was holding resources open exclusive on the server device. If the server device does not recognize the situation and close out the initial (now orphan) session before allowing the new session to complete establishment, then the client device may encounter errors attempting to re-open the resources that the client device had opened exclusive over the first session. Moreover, it also is possible for a single client device to open two or more active sessions over separate TCP/IP connections at the same time, in which case the server device must allow all of these sessions to remain open and active, and to proceed concurrently.

One conventional attempt to distinguish between active and orphan client/server session connections uses a TCP/IP KeepAlive feature or mechanism that is part of the server operating system. The TCP/IP KeepAlive feature sends a keepalive probe packet triggered by a timer. If a reply to the keepalive probe packet is received (from the client device), the connection is assumed to be up and running and the session is assumed to be active. However, the TCP/IP KeepAlive feature usually takes several minutes to determine the status of the client/server session. Accordingly, it often is possible for a client device to reboot or for a network connection to re-establish in less time than it takes the TCP/IP KeepAlive feature to execute.

Another conventional method for distinguishing between active and orphan session connections involves treating an (initial) existing session, i.e., the initial session over a different TCP/IP connection than the new session, as an orphan session that is to be terminated if the initial session is from the same client computer and uses the same credentials as the new session. Although this approach may have worked previously, recent changes to the configuration of some client devices have caused session requests from one client device under one set of credentials to sometimes arrive at the server device under multiple TCP/IP connections, rather than being multiplexed to the server over a single TCP/IP connection. Thus, such session request arrangements can result in the server device terminating existing sessions when those sessions still are active and in use.

To circumvent this problem, server devices were configured to keep track of the most recent time when sessions are active. According to such configuration, a new session that establishes within a relatively small time window (e.g., 60 seconds) of the most recent activity of an existing session does not cause the existing session to be terminated by the server device. This particular server configuration can overcome the problem in many practical cases. However, this server device configuration does not really solve the problem of distinguishing between active and orphan sessions, as sessions that should proceed in parallel can arrive more than a given time period apart, e.g., more than 60 seconds apart. Also, the loss of a connection and re-connection can occur in less than such given time period.

### SUMMARY

Disclosed is a method and apparatus for determining whether a session-based circuit or circuit connection between a first computing device, such as a server device, and a second computing device, such as a client device, is an active session that should remain open or an orphan session that should be terminated. The method includes marking the value of a TCP/IP ACK counter within the first computing device, sending a NetBios KeepAlive packet from the first computing device to the second computing device. If, after a first duration of time, the value of the TCP/IP ACK counter has not changed due to the receipt of a TCP/IP ACK by the first computing device from the second computing device, the connection is treated as an orphan session and terminated. If, within or during the first duration of time, the value of the TCP/IP ACK counter has changed due to the receipt of a TCP/IP ACK by the first computing device from the second computing device, the connection is treated as an active session and allowed to remain open. The method and apparatus provide the ability to detect or distinguish between active and orphan session-based connections.

### BRIEF DESCRIPTION OF THE DRAWINGS

FIG. 1 is a schematic view of a client/server arrangement for use in a client/server session according to an embodiment; and

FIG. 2 is a flow diagram of a method for distinguishing between active and orphan session-based connections, e.g., client/server session connections, according to an embodiment.

### DETAILED DESCRIPTION

In the following description, like reference numerals indicate like components to enhance the understanding of the disclosed method, apparatus, and system for distinguishing active and orphan session-based connections through the description of the drawings. Also, although specific features, configurations and arrangements are discussed hereinbelow, it should be understood that such is done for illustrative purposes only. A person skilled in the relevant art will recognize that other method elements, configurations and arrangements are useful without departing from the spirit and scope of the disclosure.

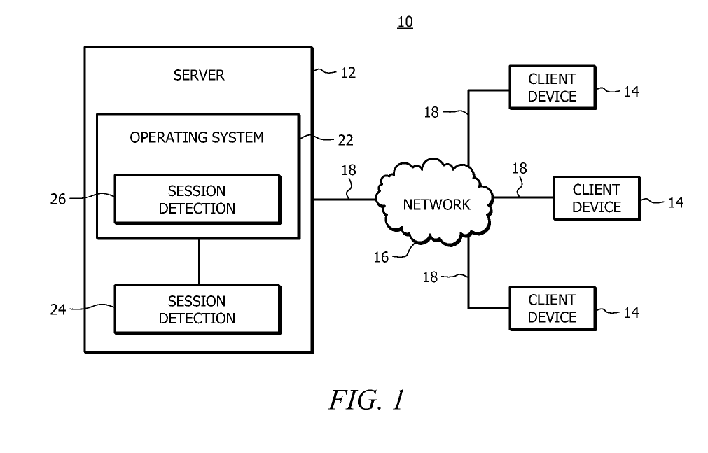

FIG. 1 is a schematic view of a client/server system or arrangement 10 for use in a client/server session in which the inventive session distinguishing or detecting method can be included. The arrangement 10 includes a server or server device 12 that is coupled or connected to one or more clients or client devices 14 through one or more networks 16 and network connections 18.

The server 12 can be any suitable computing device and/or process that provides resources to a client device. The server 12 can include an operating system 22. It should be understood that the operating system 22 can be, include, or be coupled to an emulated computing environment or operating system, such as the Master Control Program (MCP) computing environment. The operating system 22 includes or has coupled thereto a session distinguishing or detection module 24, which is or includes a method for distinguishing or detecting client/server sessions according to an embodiment. Alternatively, at least a portion of the session detecting module can reside in or be a part of the operating system, such as is shown generally by a session detection module 26 residing within the operating system 22.

The server 12 can be comprised partially or completely of any suitable structure or arrangement, e.g., one or more integrated circuits. It should also be understood that the server 12 can include other components including, without limitation, hardware and software (not shown) that are used for the operation of other features and functions of the server 12 not specifically described herein.

All relevant portions of the server 12 can be partially or completely configured in the form of hardware circuitry and/or other hardware components within a larger device or group of components. Alternatively, all relevant portions of the server 12 can be partially or completely configured in the form of software, e.g., as processing instructions and/or one or more sets of logic or computer code. In such configuration, the logic or processing instructions typically are stored in a memory element or a data storage device. The data storage device typically is coupled to a processor or controller, and the controller accesses the necessary instructions from the data storage device and executes the instructions or transfers the instructions to the appropriate location within the respective device.

The clients 14 can be any suitable client device or system that can access the server 12 via the network 16. The network 16 can be any suitable network, such as a TCP/IP network, that provides suitable network connections 18 between the server 12 and one or more of the clients 14. It should be understood that access to the network 16 by the server 12 and one or more of the clients 14 can be accomplished via any suitable transmission medium, such as one or more of coaxial cables, optical fibers, telephone wires, and/or wireless radio frequency (RF) links. Also, depending on the particular configuration of the arrangement 10, it should be understood that the server 12 and/or one or more of the clients 14 can function as a client and/or server device to other servers and/or clients.

Communication between the server 12 and the clients 14 occurs in the form of a session, using one or more communication protocols, such as the Common Internet File System (CIFS) File Access Protocol. As discussed hereinabove, there is not a suitable method or mechanism to detect a session-based connection and determine whether the connection is an active connection that is to remain open or an orphan connection that should be closed properly. Conventional session-based connection determining methods that involve a TCP/IP KeepAlive feature typically either are too time consuming or fail to properly determine the status of a session-based connection because of the time required to perform the TCP/IP KeepAlive feature. Other conventional methods that rely on client device identity and/or session credentials often create unnecessary multiple connections or erroneously terminate connections that are not orphans due to recent configuration changes in some client devices.

In conventional CIFS implementations within actual and emulated operating systems, most messages from the server are sent to the client in response to one or more requests from the client, and hence are not spontaneously sent by the server to the client to detect if the session-based connection, e.g., the TCP/IP connection, therebetween still is alive. However, there are two exceptions. The first exception is a Request to “break” an “opportunistic lock.” If the server has granted the client an “opportunistic lock,” the server can spontaneously send the client a Request to return ownership of the resource to the server, i.e., “break” the lock.

The second exception is a NetBios KeepAlive feature. Some client server protocols are implemented over the NetBios over TCP/IP protocol. This protocol contains a NetBios KeepAlive feature that can transmit a four byte KeepAlive packet. More recent CIFS implementations use a protocol that is a subset of the TCP/IP protocol, but this protocol retains the KeepAlive packet transmission feature. As discussed hereinabove, in general, a keepalive feature sends a keepalive probe packet, and if a reply to the keepalive probe packet is received, the connection is assumed to be up and running and the session still open and active. However, a problem with using the NetBios KeepAlive feature to detect the status of session-based connections is that, according to the NetBios over TCP/IP protocol, the receiving end of the KeepAlive probe packet (i.e., the client device) simply quietly consumes the KeepAlive packet. Thus, within the context of the NetBios over TCP/IP protocol, there is no response from the client device back to the server.

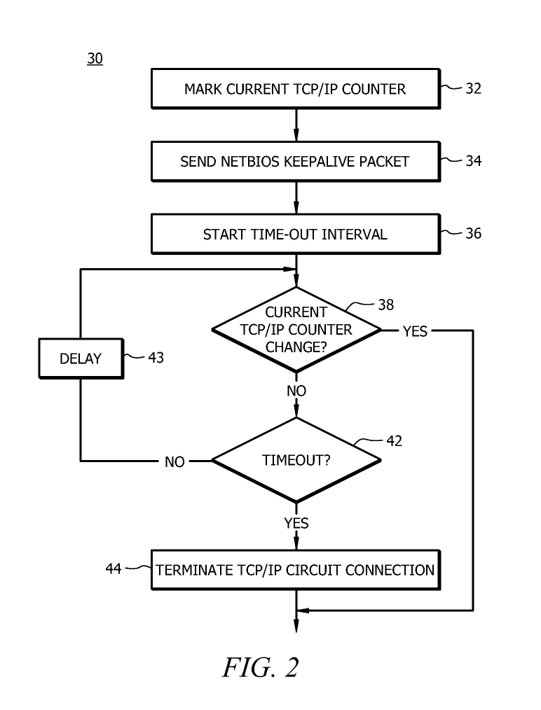

FIG. 2 illustrates a flow diagram 30 of a method for distinguishing between active and orphan session-based connections, e.g., client/server session connections, according to an embodiment. This inventive method can be used by a server device or other appropriate computing device that wishes to detect whether or not an existing TCP/IP circuit or other session-based connection still is alive. The inventive distinguishing method makes use of an existing response to the transmission of a NetBios KeepAlive packet according to the NetBios KeepAlive feature. As part of the protocol involving the NetBios KeepAlive feature, the receiving end of a transmitted KeepAlive packet (e.g., a client device) transmits, via the TCP/IP layer, a TCP/IP ACK response back to the sender of the KeepAlive packet. Thus, the inventive distinguishing method makes use of the TCP/IP ACK response to determine if a session-based connection is an active connection, and therefore should remain open, or an orphan connection that is to be closed or terminated.

Unlike conventional keepalive mechanisms, such as the TCP/IP KeepAlive mechanism, the NetBios KeepAlive feature sends NetBios KeepAlive packets and other new data via the application layer. The TCP/IP keepalive mechanism and other conventional keepalive mechanisms send keepalive packets via the TCP/IP layer. Therefore, according to the inventive distinguishing method, the application layer can invoke the NetBios KeepAlive feature synchronously, which allows the status of a session-based connection to be determined before proceeding further with the establishment of a new session-based connection. Also, the application layer can implement any time-out intervals that may be used.

The method includes a step 32 of marking or saving the current value of the TCP/IP ACK counter. According to the TCP/IP protocol, the TCP/IP ACK counter is a variable that indicates the current number of bytes of a particular data message that has been received by the client device, via an acknowledgement by the client device to the server device of the successful receipt of the data bytes. According to the marking step 32, the value of the TCP/IP ACK counter is marked or noted just prior to sending a NetBios KeepAlive packet. For example, just before a NetBios KeepAlive packet is sent to a client device, the marking step 32 saves the value of the TCP/IP ACK counter as a CURRENTACK variable, e.g., in a separate memory location.

The method includes a step 34 of sending a NetBios KeepAlive packet to the client device. The NetBios KeepAlive packet can be any suitable length, e.g., four bytes. The NetBios KeepAlive packet is sent to the client device via the application layer. Using the application layer to invoke the NetBios KeepAlive feature allows for the status of a session-based connection to be determined at a more appropriate time than in conventional methods. For example, the NetBios KeepAlive feature can be invoked in a manner that allows the status of a session-based connection to be determined before proceeding further with the establishment of a new session-based connection. Conventional keepalive methods, which tend to be only time-based, do not provide for such synchronous implementation of a keepalive feature.

The method includes a step 36 of initiating a time-out interval. As will be discussed in greater detail hereinbelow, a time-out interval is initiated so that a determination can be made as to how long after the server has sent a NetBios KeepAlive packet to the client device it takes a TCP/IP ACK response sent by the client device to be received by the server device. According to the embodiments, the application layer can implement a time-out interval for this purpose or any other suitable purpose.

The method includes a step 38 of determining whether the value of the current TCP/IP counter has changed. As discussed hereinabove, according to the NetBios over TCP/IP protocol, the client device consumes any received NetBios KeepAlive packet and does not send any return data packet to the server device that sent the NetBios KeepAlive packet. However, according to the TCP/IP protocol, for active session connections, the client device does send a TCP/IP ACK response, via the TCP/IP layer, to the server device in response to the client device receiving the NetBios KeepAlive packet from the server device. If the session connection is an orphan session connection or otherwise is no longer active, no TCP/IP ACK response is sent by the client device to the server device.

According to the TCP/IP protocol, the TCP/IP ACK response includes a new or updated TCP/IP ACK counter value. When the server device receives the TCP/IP ACK response, the existing value of the TCP/IP ACK counter is replaced with the new or updated TCP/IP ACK counter value from the TCP/IP ACK response. Therefore, if the server device receives the TCP/IP ACK response, the value of the current TCP/IP ACK counter changes.

The determining step 38 determines if the value of the current TCP/IP ACK counter changes in any suitable manner. For example, as discussed hereinabove, if the current value of the TCP/IP ACK counter was saved as a CURRENTACK variable just prior to the NetBios KeepAlive packet being sent to the client device, the determining step 38 can determine if the value of the current TCP/IP ACK counter has changed by comparing the value of the current TCP/IP ACK counter to the value of the CURRENTACK variable. If the value of the current TCP/IP ACK counter is the same as the value of the CURRENTACK variable, the value of the current TCP/IP ACK counter has not changed, meaning that the server device has not received a TCP/IP ACK response from the client device. If the value of the current TCP/IP ACK counter is not the same as the value of the CURRENTACK variable, the value of the current TCP/IP ACK counter has changed, meaning that the server device has received a TCP/IP ACK response from the client device and the updated TCP/IP ACK counter value from the TCP/IP ACK response has replaced the existing value of the TCP/IP ACK counter.

According to the determining step 38, if the value of the current TCP/IP ACK counter has not changed (N), the inventive method continues to the next step, as will be discussed hereinbelow. However, if the value of the current TCP/IP ACK counter has changed (Y), the inventive method performs no further steps, i.e., the session-based circuit or circuit connection remains open and active. Therefore, if the server device receives a TCP/IP ACK response from the client device to which the server device sent the NetBios KeepAlive packet, the session-based circuit or circuit connection therebetween is not terminated, and therefore remains open and active.

The method includes a step 42 of determining whether the time-out interval has expired. According to an embodiment, the time-out interval can be set to any suitable value, e.g., depending on the system configuration within which the server/client sessions are operating. Also, it should be understood that the time-out interval can be manifested in the form of a loop count limit having a set time period nested therein. As discussed hereinabove, just after the server device sends a NetBios KeepAlive packet to the client device, a time-out interval is initiated (step 36). Then, if the determining step 38 determines that the value of the current TCP/IP ACK counter has not changed (N), meaning that the server device has not received a TCP/IP ACK response from the client device, the determining step 42 then determines whether or not the time-out interval has expired.

If the determining step 42 determines that the time-out interval has not expired (N), the method returns to the step 38 of determining whether or not the value of the current TCP/IP ACK counter has changed, after a delay 43. If the determining step 42 determines that the time-out interval has expired (Y), meaning that the server device has not received a TCP/IP ACK response from the client device within the duration of time established by the time-out interval, the inventive method continues to the next step, as will be discussed hereinbelow.

The method includes a step 44 of terminating the existing TCP/IP circuit or other session-based connection between the server device and the client device. If the determining step 42 determines that the time-out interval has expired (Y) before any change to the value of the current TCP/IP counter, then the server device has not received a TCP/IP ACK response from the client device within the amount of time established by the time-out interval. Therefore, the existing TCP/IP circuit or connection is determined to be an orphan session and is terminated. According to the embodiment, the orphan session circuit or connection is terminated in an appropriate manner.

Once the orphan session connection has been terminated properly, a new session-based connection can be opened and will have access to resources previously in use by the previous, just-terminated orphan session. In this manner, the opening of a new session connection can be synchronized with the closing of an orphan session connection before establishing the new session connection. Such synchronization can eliminate the errors associated with attempting to re-open session resources that previously were being held open for a session connection that turned into an orphan session.

One or more of the functions performed in the inventive method can be performed in any suitable manner by any appropriate component or components. For example, the operating system of the server 12 can mark the current TCP/IP counter 32, send the NetBios KeepAlive packet 34, determine if there has been a change to the current TCP/IP counter 36, determine if a timing out process has occurred 38, and/or terminate the TCP/IP circuit connection 42. Alternatively, one or more of these functions can be performed completely or partially by other components within the server 12 and/or coupled to the server 12.

The method illustrated in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, and silicon memory (e.g., removable, non-removable, volatile or non-volatile).

It will be apparent to those skilled in the art that many changes and substitutions can be made to the embodiments described herein without departing from the spirit and scope of the invention as defined by the appended claims and their full scope of equivalents.

1. A method for determining the status of a session connection between a first computing device and a second computing device, wherein the session connection has associated therewith a communication protocol that includes the generation of a NetBios KeepAlive packet and a TCP/IP ACK response to the NetBios KeepAlive packet, the method comprising:
marking the value of a TCP/IP ACK counter within the first computing device;
sending a NetBios KeepAlive packet from the first computing device to the second computing device;
if, after a first duration of time, the value of the TCP/IP ACK counter has not changed, terminating the session connection between the first computing device and the second computing device; and
if, during the first duration of time, the value of the TCP/IP ACK counter changes, keeping the session connection between the first computing device and the second computing device open and active.

2. The method as recited in claim 1, wherein the value of the TCP/IP ACK counter changes when the first computing device receives from the second computing device the TCP/IP ACK response to the NetBios KeepAlive packet.

3. The method as recited in claim 1, wherein the TCP/IP ACK response to the NetBios KeepAlive packet includes an updated TCP/IP ACK counter value, and wherein the TCP/IP ACK response to the NetBios KeepAlive packet updates the value of the TCP/IP ACK counter when the first computing device receives from the second computing device the TCP/IP ACK response to the NetBios KeepAlive packet.

4. The method as recited in claim 1, wherein the communication protocol includes a TCP/IP layer, and wherein the TCP/IP ACK response is sent by the second computing device and received by the first computing device via the TCP/IP layer.

5. The method as recited in claim 1, wherein the communication protocol includes an application layer and a TCP/IP layer, and wherein sending the NetBios KeepAlive packet further comprises sending the NetBios KeepAlive packet by the first computing device to the second computing device via the application layer.

6. The method as recited in claim 1, wherein the first duration of time is determined by a time-out mechanism.

7. The method as recited in claim 6, wherein the communication protocol includes an application layer and a TCP/IP layer, and wherein the time-out mechanism is implemented via the application layer

8. The method as recited in claim 1, wherein marking the value of the TCP/IP ACK counter includes setting a CURRENTACK variable equal to the current value of the TCP/IP ACK counter, and wherein the method further comprises determining if the value of the TCP/IP ACK counter has changed by comparing the value of the CURRENTACK variable to the value of the TCP/IP ACK counter.

9. The method as recited in claim 1, wherein the first computing device is a server device, wherein the second computing device is a client device, and wherein the session connection is a client/server session.

10. A computing device, comprising:
an operating system; and
a client/server session detection module coupled to the operating system, wherein the client/server session detection module is configured to
mark the value of a TCP/IP ACK counter,
send a NetBios KeepAlive packet to a client device coupled to the computing device via a client/server session-based connection,
if, after a first duration of time, the value of the TCP/IP ACK counter has not changed, terminate the client/server session-based connection between the computing device and the client device, and
if, during the first duration of time, the value of the TCP/IP ACK counter changes, keep the client/server session-based connection between the computing device and the client device open and active.

11. The device as recited in claim 10, wherein the value of the TCP/IP ACK counter changes when the first computing device receives from the second computing device a TCP/IP ACK response to the NetBios KeepAlive packet.

12. The device as recited in claim 11, wherein the TCP/IP ACK response to the NetBios KeepAlive packet includes an updated TCP/IP ACK counter value, and wherein the TCP/IP ACK response to the NetBios KeepAlive packet updates the value of the TCP/IP ACK counter when the first computing device receives from the second computing device the TCP/IP ACK response to the NetBios KeepAlive packet.

13. The device as recited in claim 10, wherein the client/server session-based connection has associated therewith a communication protocol that includes the generation of a NetBios KeepAlive packet and a TCP/IP ACK response to the receipt of the NetBios KeepAlive packet.

14. The device as recited in claim 10, wherein the client/server session-based connection has associated therewith a communication protocol that includes an application layer and a TCP/IP layer, and wherein the computing device is configured to receive a TCP/IP ACK response from the client device via the TCP/IP layer.

15. The device as recited in claim 10, wherein the client/server session-based connection has associated therewith a communication protocol that includes an application layer and a TCP/IP layer, and wherein the computing device is configured to send the NetBios KeepAlive packet to the client device via the application layer.

16. The device as recited in claim 10, wherein the client/server session detection module is configured to determine the first duration of time using a time-out mechanism.

17. The device as recited in claim 10, wherein the client/server session detection module is configured to mark the value of the TCP/IP ACK counter by setting a CURRENTACK variable equal to the current value of the TCP/IP ACK counter, and wherein the client/server session detection module is configured to determine if the value of the TCP/IP ACK counter has changed by comparing the value of the CURRENTACK variable to the value of the TCP/IP ACK counter.

18. The device as recited in claim 10, wherein at least a portion of the client/server session detection module resides in the operating system.

19. The device as recited in claim 10, wherein the computing device is a server connected to a client device within a client/server session.

20. The device as recited in claim 10, wherein the computing device is a client device connected to a server device within a client/server session.

21. A computer readable medium having instructions stored thereon which, when executed by a processor, carry out a method for determining the status of a session connection between a first computing device and a second computing device, the instructions comprising:
instructions for marking the value of a TCP/IP ACK counter;
instructions for sending a NetBios KeepAlive packet from the first computing device to the second computing device;
instructions for terminating the session connection between the first computing device and the second computing device if, after a first duration of time, the value of the TCP/IP ACK counter has not changed; and
instructions for keeping the session connection between the first computing device and the second computing device open and active if, during the first duration of time, the value of the TCP/IP ACK counter changes.
